(19) United States
(12) Patent Application Publication
(10) Pub. No.: US 2012/0095984 A1
(43) Pub. Date: Apr. 19, 2012

(54) Universal Search Engine Interface and Application

(76) Inventors: Peter Michael Wren-Hilton, Tauranga (NZ); Olena Medelyan, Auckland (NZ); Nicholas Allan Waterhouse, Hamilton (NZ)

(21) Appl. No.: 12/906,984

(22) Filed: Oct. 18, 2010

(51) Int. Cl. G06F 17/30

(52) U.S. Cl. 707/707; 707/E17.108

(57) ABSTRACT

Disclosed are methods, systems, apparatus and products, including a method that includes receiving, by at least one processor-based device, a search query provided via an interface, and submitting the search query to at least one of a plurality of search engines, each having a dedicated search engine interface, the dedicated search engine interface of the at least one of the plurality of search engines being hidden from view by the interface. The method also includes selecting a subset of search results returned by the at least one of the plurality of search engines, and determining a set of possible query variations based on the selected subset of search results, the set of possible query variations being used to determine one or more refined queries for resubmission to the at least one of the plurality of search engines.

### BACKGROUND

The present disclosure relates to search engines, and more particularly to a search engine application and interface to interact with other search engine applications and to facilitate refinement of search queries.

A user seeking information about a particular subject matter may submit a query to any number of commercially available search engines that can search and retrieve data accessible by the search engine. For example, Internet-based search engines (e.g., Google™, Bing™, etc.) search for data relevant to the search query that is available on, for example, private networks (intranets), as well as public networks (e.g., the Internet).

Enterprise search engines that access data stored on private networks, as well as search engines available on public networks, may retrieve and return a very large number of hits for every query submitted. Many of the returned search results may not be relevant or may not include the exact information the user was looking for, often because the query itself was not specific or refined enough to enable the return of better quality and/or more relevant search results. In such circumstances, the user may need to devise a more refined search, which may be a difficult challenge for the user.

### SUMMARY

Described herein are methods, systems, apparatus and computer program products, including a method that includes receiving, by at least one processor-based device, a search query provided via an interface, and submitting, by the at least one processor-based device, the search query to at least one of a plurality of search engines each having a dedicated search engine interface, the dedicated search engine interface of the at least one of the plurality of search engines being hidden from view by the interface. The method also includes selecting, by the at least one processor-based device, a subset of search results returned by the at least one of the plurality of search engines, and determining, by the at least one processor-based device, a set of possible query variations based on the selected subset of search results, the set of possible query variations being used to determine one or more refined queries for resubmission to the at least one of the plurality of search engines.

In one aspect, a method is disclosed. The method includes receiving, by at least one processor-based device, a search query provided via an interface, submitting, by the at least one processor-based device, the search query to at least one of a plurality of search engines, each having a dedicated search engine interface, the dedicated search engine interface of the at least one of the plurality of search engines being hidden from view by the interface, selecting, by the at least one processor-based device, a subset of search results returned by the at least one of the plurality of search engines, and determining, by the at least one processor-based device, a set of possible query variations based on the selected subset of search results, the set of possible query variations being used to determine one or more refined queries for resubmission to the at least one of the plurality of search engines.

Embodiments of the method may include any of the features described in the present disclosure, including any of the following features.

Determining the set of possible query variations may include generating an index of word combinations from referenced data corresponding to the selected subset of search results, and determining query variations based on the generated index of word combinations.

Determining the query variations may include identifying equivalent terms of words comprising the search query, and determining for one or more of the identified equivalent terms whether the one or more equivalent terms is included in the generated index of word combinations.

Determining the query variations may include identifying, based on the generated index and the search query, one or more terms satisfying one or more specified requirements, the one or more identified terms including terms that at least one of, for example, do not match any portion of the search query, are not sub-phrases of one or more phrases, appear at least once in data referenced by the subset of search results, have a computed weight exceeding a predetermined value, and/or appear in paragraphs that include at least one of terms of the search query.

Determining the query variations may also include presenting the identified one or more terms as possible query refinements.

The method may further include determining one or more subject matter categories associated with the identified terms that are to be presented as possible query refinements.

The method may further include determining the one or more refined queries to be submitted to the at least one of the plurality of search engines based on the determined variations of the search query and input received from a user presented with the determined query variations, and submitting the one or more refined queries to the at least one of the plurality of search engine to generate a further set of search results retuned by the at least one of the plurality of search engines in response to the one or more refined queries.

Generating the index of word combination may include identifying word combinations in the referenced data, computing a weight for each of the identified word combinations based on statistics associated with content maintained in a public data repository, and adding the identified word combinations to the index of word combinations.

The method may further include normalizing the identified word combinations, the normalizing including one or more of, for example, converting text data of the identified word combinations to one of a lower case and an upper case, discarding words matching pre-defined stopwords, and/or re-arranging an order of words within the identified word combinations.

The method may further include identifying keywords associated with the referenced data associated with each of the returned search results.

Identifying keywords may include identifying from the index of word combinations candidate terms, including terms matching terms of the query, and terms appearing in paragraphs of the referenced data in which the terms of the query appear, computing a score for each of the candidate terms, and selecting one or more of the candidate terms based on the computed score for each of the candidate terms.

Computing the score for each of the candidate terms may include computing a score for a particular candidate term based on the formulation:

$$score ( candidate ) = pf {\sum }_{n ∈ N}^{ } wn \vert N \vert$$

where p is number of paragraphs in which there is a co-occurrence of the particular candidate term and one or more of the query terms, f is the relative distance of the candidate keyword from the beginning of the referenced data, N is a set of equivalent word combinations stored in the index entry corresponding to the candidate term, and w is the score given to a phrase from the set of phrases.

The method may further include determining a representative paragraph of a document corresponding to the referenced data.

Determining the representative paragraph may include computing a score for each sentence in the referenced data based, at least in part, how many times one or more of the terms of the query appear in the respective each sentence, and computing a score for each paragraph of the references data based, at least in part, on the scores of sentences in the each paragraph.

The method may further include generating an extensible markup language (XML) document including at least some paragraphs of the referenced data, the paragraphs being ranked according to scores computed for each of the paragraphs. The method may also include including complementary data from external resources with the XML document, and generating a portable document format (PDF) document from the XML document.

The method may further include assigning permission parameters to the PDF document to control subsequent access to the PDF document, and storing the PDF document with the assigned permission parameters in a data repository.

Storing the PDF document in the data repository may include storing the PDF document in a server including one or more web pages.

In another aspect, a system is disclosed. The system includes at least one processor-based device, and at least one memory storage device coupled to the at least one processor-based device. The at least one memory storage device includes computer instructions that, when executed on the at least one processor-based device, cause the at least one processor-based device to receive a search query provided via an interface, and submit the search query to at least one of a plurality of search engines, each having a dedicated search engine interface, the dedicated search engine interface of the at least one of the plurality of search engines being hidden from view by the interface. The computer instructions further cause the at least one processor-based device to select a subset of search results returned by the at least one of the plurality of search engines, and determine a set of possible query variations based on the selected subset of search results, the set of possible query variations being used to determine one or more refined queries for resubmission to the at least one of the plurality of search engines.

Embodiments of the system may include any of the features described in the present disclosure, including any of the features described above in relation to the method, and the features described below.

In a further aspect, disclosed is a computer program product embodied on a non-transitory computer readable storage medium containing computer instructions. The computer instructions include instructions that, when executed on at least one processor-based device, cause the at least one processor-based device to receive a search query provided via an interface, and submit the search query to at least one of a plurality of search engines, each having a dedicated search engine interface, the dedicated search engine interface of the at least one of the plurality of search engines being hidden from view by the interface. The computer instructions further cause the at least one processor-based device to select a subset of search results returned by the at least one of the plurality of search engines, and determine a set of possible query variations based on the selected subset of search results, the set of possible query variations being used to determine one or more refined queries for resubmission to the at least one of the plurality of search engines.

Embodiments of the computer program product may include any of the features described in the present disclosure, including any of the features described above in relation to the method and the system, and the features described below.

Details of one or more implementations are set forth in the accompanying drawings and in the description below. Further features, aspects, and advantages will become apparent from the description, the drawings, and the claims.

### BRIEF DESCRIPTION OF THE DRAWINGS

FIG. 1 is a block diagram of an example universal search engine application, such as the PINGAR™ application, to interact with one or more search engines.

FIG. 2A is a screenshot of an example user interface (also referred to as a dashboard).

FIG. 2B is a screenshot of the example dashboard presenting additional information in relation to a selected item.

FIG. 3 is a screenshot of an example interface integrated into a Microsoft SharePoint™ environment.

FIG. 4 is a flow diagram of a procedure to generate an index of word combinations from data referenced by the search results.

FIG. 5 is a flow diagram of an example procedure to determine expansion suggestions.

FIG. 6 is a flow diagram of an example refinement suggestions procedure.

FIG. 7 is a screenshot of an example dashboard illustrating operation of the procedures to determine possible expansion suggestions and refinement suggestions.

FIG. 8 is a screenshot of an example dashboard providing query variations and enabling determining a refined search query.

FIG. 9 is a flow diagram of an example procedure to extract keywords.

FIG. 10 is a flow diagram of an example procedure to identify a paragraph(s) and/or sentence(s) that are deemed to best represent the document corresponding to one of the returned search results.

FIG. 11 is a flow diagram of an example procedure to select the content to be used for generating search reports.

FIG. 12 is a flow diagram of an example report generation procedure.

FIG. 13 is a screenshot of an example PDF search report.

FIG. 14 is a screenshot of a first page of another example search report.

FIG. 15 is a schematic diagram of an example computing-based system.

Like reference numbers and designations in the various drawings indicate like elements.

### DETAILED DESCRIPTION

Described herein are methods, systems, apparatus and computer program products, including a method that includes receiving, by at least one processor-based device, a search query provided via an interface, and submitting, by the at least one processor-based device, the search query to at least one of a plurality of search engines (search engines such as, for example, Google™, Bing™, Yahoo™, etc.) each having a dedicated search engine interface, the dedicated search engine interface of the at least one of the plurality of search engines being hidden from view by the interface. The method further includes selecting, by the at least one processor-based device, a subset of search results returned by the at least one of the plurality of search engines, and determining, by the at least one processor-based device, a set of possible query variations based on the selected subset of search results. The set of possible query variations is used to determine one or more refined queries for resubmission to the at least one of the plurality of search engines.

In some embodiments, determining the refined query may include generating an index of word combinations from data sources (e.g., documents) corresponding to the selected subset of search results, and determining variations of the search query based on the generated index of word combinations. In some embodiments, results returned by the at least one search engine accessed via the universal search engine (e.g., after one or more iterations of refining the search query submitted to the search engines via the universal search engine platform) are processed to, for example, identify relevant paragraphs within the identified relevant search results, and generate extensible markup language (XML) and/or portable document format (PDF) documents (e.g., generate an intermediate XML document, which is converted to a PDF) based on the processed search results. Those generated formatted documents may be stored in data repositories for subsequent access and use by authorized users (which may avoid the need to devise and re-submit queries, and go through the process of reviewing search results, refining queries, re-submitting the refined queries, etc.)

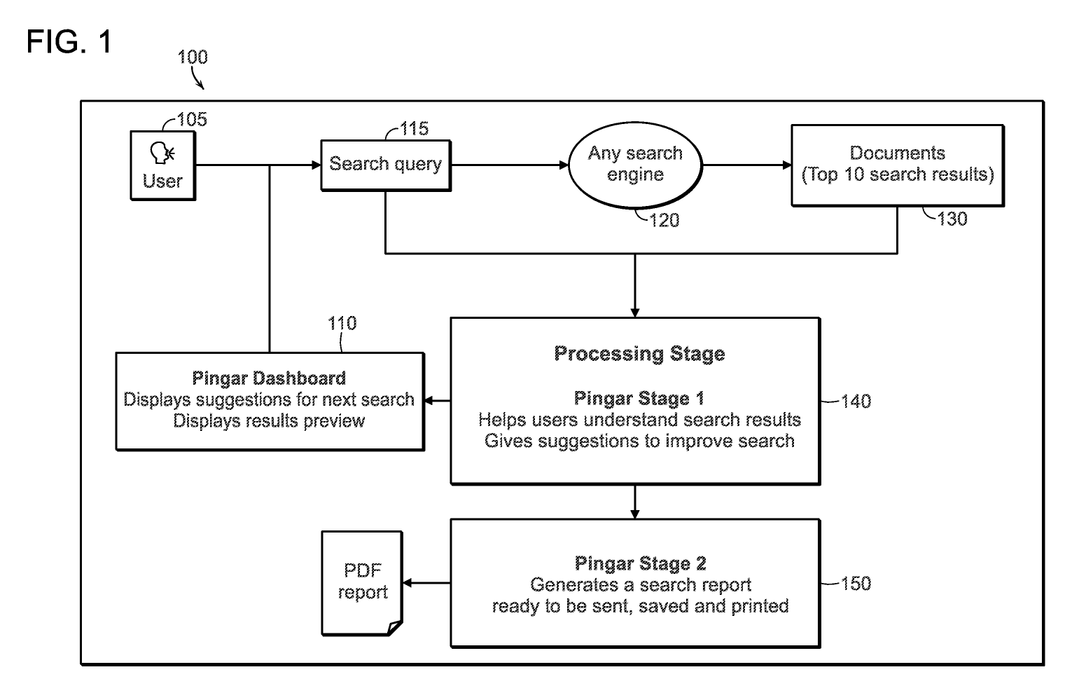

With reference to FIG. 1, a block diagram of an example application of a universal search engine, such as the PINGAR™ application, to interact with one or more search engines, is shown. Although the Pingar™ application is depicted, other applications may be used as well. The application 100 includes a user interface 110 through which a user, such as a user 105, may submit queries to search for information the user is interested in, review processed search results returned by at least one of a plurality of remote search engines processing the query, and determine possible query variations (expansions and/or refinements), presented on the user interface 110, which may result in better quality and/or more relevant search results when the current query is refined according to the proposed query variations, and the refined query is submitted to the at least one of the plurality of search engines. In some embodiments, the user and/or an administrator/technician may also set, e.g., via the interface 110, various features and parameters used to control the search (e.g., control the number of results returned, control the time period associated with the data searched, etc.) The application 100, including the application's user interface 110, may be installed locally at a user's computing device, in which case the user's computing device may be executing locally an instance of the application. In some embodiments, at least part of processes of the application 100 may be executing at a remote computing device (e.g., a server), with the interface being presented to the user via a user interface such as for example, a browser. In such implementations, a remote web server may send data to enable presentation of the interface and to enable receipt of user data (e.g., by sending to the user's local computing device markup language data, scripted data, such as JavaScript, etc.)

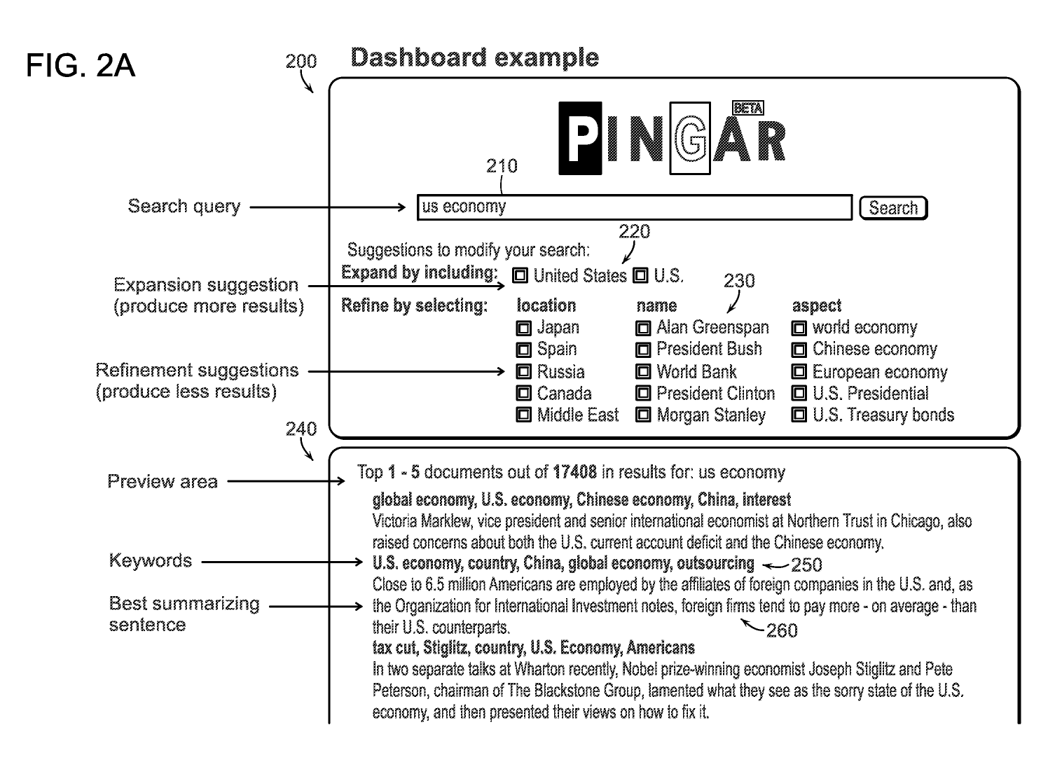

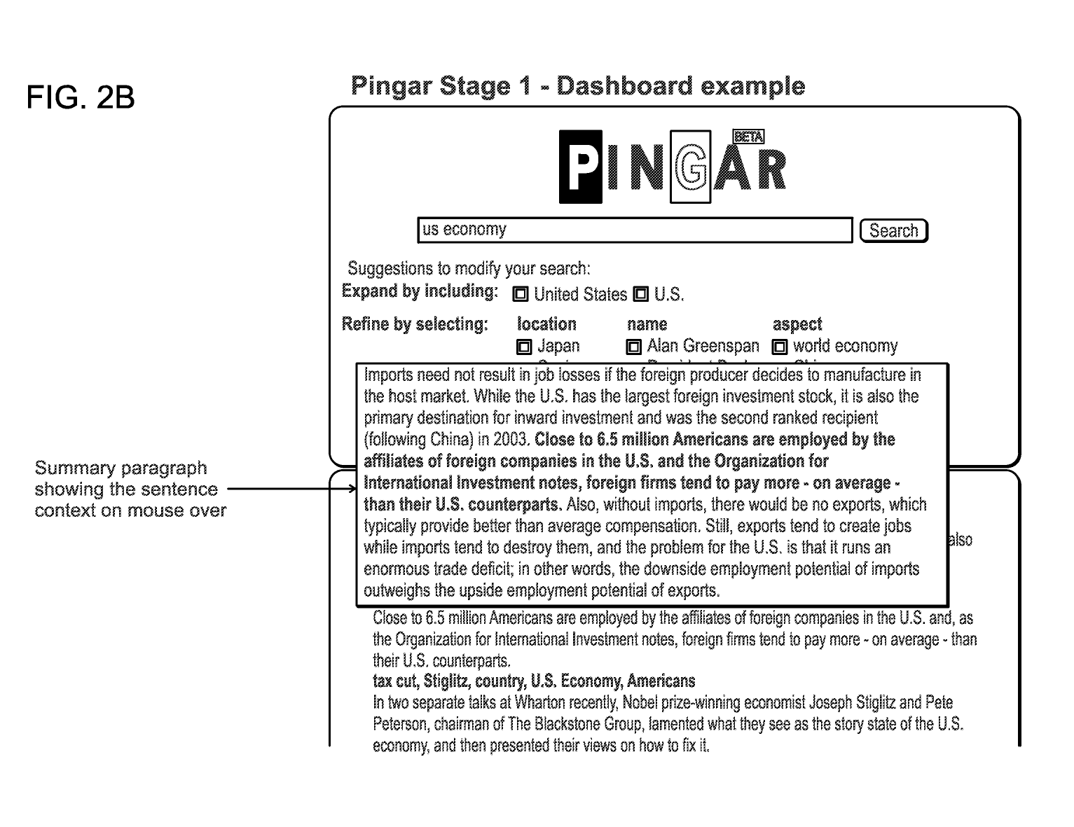

With reference to FIG. 2A, a screenshot of an example user interface 200 (also referred to as a dashboard), which may be similar to the user interface 110 of FIG. 1 (or may be an example implementation of the interface 110), through which a user may submit queries is shown. In some implementations, the user interface may include a query area 210 through which a user may construct queries. As will be described in greater detail below, the application 100 processes search results it receives back from the at least one of the plurality of search engines to determine possible query variations that the user may wish to select to modify the search query to obtain a more refined query, and thus obtain more refined search results. The user interface 200 therefore includes an expansion suggestion area 220 to present expansion suggestions to modify the query (which may result in more search results), and a refinement suggestion area 230 to present refinement suggestion generated by the application 100 (which may result in fewer search results).

In some implementations, the interface 200 may also include a preview area 240 where processed search results, obtained through submission of the current query to the at least one of the plurality of search engines with which the application 100 communicates, are presented. As will be described in greater detail below, the preview area 240 presents, for each document corresponding to a returned search result, a list of keywords determined to be the most significant keywords in the document (determination of keyword is performed based on the current query and based on an index of word combinations generated for returned search results). For example, data item 250 includes a list of five keyword associated with one of the documents corresponding to the search results. Also presented in the interface 200 is a sentence (and/or paragraph) determined to be representative of the particular document that includes that paragraph. For example, data item 260 includes a representative sentence of the document associated with it. In the embodiments of FIG. 2A, the list of keywords of a particular document is presented immediately above the representative paragraph for that document.

In some embodiments, if the user wishes to obtain more information in relation to any of the sentences presented in the preview area 240, the user, for example, may move a mouse cursor over the area including the presented sentence, which in turn causes a magnified window to be presented over interface 200, in which more of the content that includes the previewed sentence is presented. FIG. 2B is a screenshot of the example dashboard 200 in which the user has indicated (e.g., by moving the mouse cursor) it wishes to review more of the content associated with the data item 260. In response to moving the cursor over the desired area (or in response to selecting the item is some other manner), a larger portion of the content associated with the data item 260 shown in FIG. 2A is presented.

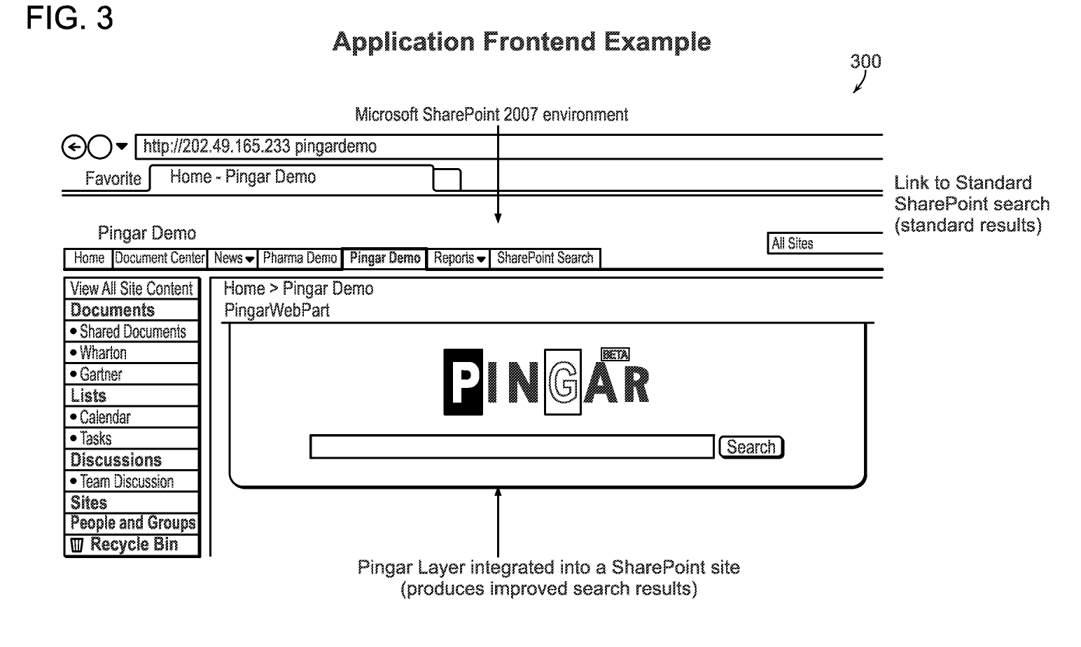

FIG. 3 illustrates an example of an interface 300 of the application 100 (e.g., a Pingar™ interface) integrated into a Microsoft SharePoint™ 2007 environment. As shown, the interface of the host application (in this case the SharePoint™ application) may be configured so that it includes an integrated interface similar to the interfaces 110 or 200 of FIGS. 1 and 2, respectively. Such integration may be performed by running software on the computer/server hosting, for example, the SharePoint™ application. Alternatively, in some implementations, when the interface used to access that application is a browser-based interface presented at a user's local computer (e.g., the same computer where the user interface 110 of the application may be presented), the browser may be configured so that when accessing the SharePoint™ server, the interface presented on the user's browser is an interface similar to the interface 300. When an interface such as the interface 300 is integrated into, for example, a SharePoint™ environment, the integrated environment may thus become configured to enable simple and efficient recordation of any of the processed search results (or other information), obtained through operation of the application 100, into the SharePoint™ repository and environment.

Returning to FIG. 1, the application 100 is configured to communicate with a plurality of search engine applications 120, such as, for example, Google™, Bing™, Yahoo™, etc., to submit queries entered by the user through the interface 110 to at least one of the plurality of search engines, and to retrieve and present to the user search results obtained when the query is executed by the at least one of the plurality of the search engines. Thus, in some embodiments, the one or more search engine applications 120 are hidden so that their respective dedicated interfaces are not presented (at least not to a user interacting through the user interface 110). These contacted at least one of the plurality of search engines may thus be considered to effectively operate as background or subordinated applications of the application 100. In some embodiments, a browser (in implementations where the interface 110 is presented via a browser) may be configured to present the interface 110 even when some other search engine interface is sought to be accessed. Thus, for example, when the user attempts to directly access a particular search engine application (e.g., by directly specifying the particular search engine's URL), the configured browser may instead present the user interface 110 with the respective dedicated user interface of the search engine application attempted to be accessed being hidden from view (although, as described herein, queries entered through an interface such as the interface 110, are subsequently submitted to the underlying search engine application the user sought to contact). Similarly, and as previously described in relation to FIG. 3, interfaces of other applications may also be configured to present interfacing feature of an interface such the interface 110.

Thus, upon submission of a search query 115 to the at least one of the plurality of search engines applications with which the application 100 is communicating, the at least one of the plurality of search engines 120 runs the submitted query and returns 130 all, or a subset of, the corresponding search results. For example, in some embodiments, a search engine application may return only the top 10 search results (returned as links to data identified for the submitted query, and/or at least some content from the linked data source).

The returned search results are subsequently processed by the application's 100 processing stage module 140. The processing stage module 140 is configured to help users understand search results, and to facilitate refining the previously submitted query, based on the returned results 130, so as to improve the quality and relevance of subsequent search results (determined in subsequent iterations). As will be described in greater detail below, the processing of returned search results in a given iteration includes, for example, generating an index of word combinations from documents corresponding to the subset of search results returned from the at least one search engine application, and determining variation of the search query based, at least in part, on the generated index of word combinations. For example, based on the processing of the search results returned by the at least one search engine with which the application 100 communicated, the application 100 determines a set of one or more proposed variations (refinements and/or expansions) for the query previously submitted that may be presented via the interface 110 (which may be similar to the dashboard 200 shown in FIG. 2A). At least one of the proposed variations may then be selected (by the user or automatically), and resubmitted to the at least one search engine that returned the results (or optionally to another search engine application) to thus obtain more refined search results. The returned search results are again processed to determine further possible variations. The iterative operations/processing of application 100 may continue until the user is satisfied with the quality and/or relevance of returned search results from the at least one search engine. Alternatively, in some embodiments, the iterative process implemented by the application 100 may terminate upon completion of some pre-determined number of iterations (e.g., 2, 5, 10, 50, 100, or any other number of iterations), and/or upon a determination that the search results meet or exceed some pre-determined value representative of quality and/or relevance of the search results. For example, the application 100 may compute relevance scores for at least some of the data obtained via the at least one search engine. Accordingly, in some embodiments, a metric based on the computed relevancy scores may be determined, and that determined metric may also be used to determine if further iteration(s) of the operations/processing of the application 100 are required. The processing performed at 140 may also include determining keywords associated with documents corresponding to the returned search results, and determining sentences and/or paragraphs representative of the documents.

As further shown in FIG. 1, the application 100 also includes generating a search report based on the processed search results. That search report may be generated at the end of every iteration, or after the iterative process of refining and submitting queries has concluded. The search report may include portions of the search results data, and may be supplemented with data from other sources. The search report may be generated as, for example, a PDF document, or as some other type of document, and may then be saved in a data repository, such as, for example, SharePoint™, whereupon the search report may subsequently be accessed by authorized users. In some embodiments, the search report may be stored with permission parameters indicative of the authorization level required to access and/or retrieve the search report.

Thus, based on the processing performed on the subset of returned results, the application 100 may, for example: 1) identify paragraphs and sentences in the data corresponding to the subset of returned results, 2) match the submitted search queries to content represented by the data of the returned results, 3) generate query expansion suggestions (e.g., possible queries that include terms equivalent to those in the just submitted query), 4) generate refinement suggestions (e.g., possible terms that can be added to the just submitted query to obtain better quality and/or more relevant results), 5) generate key words for each data source (i.e., a hit) listed in the subset of returned results, and/or 6) identify the “best” (based on some pre-determined definition of what constitutes “best”) paragraphs and sentences in each of the data sources corresponding to the returned results.

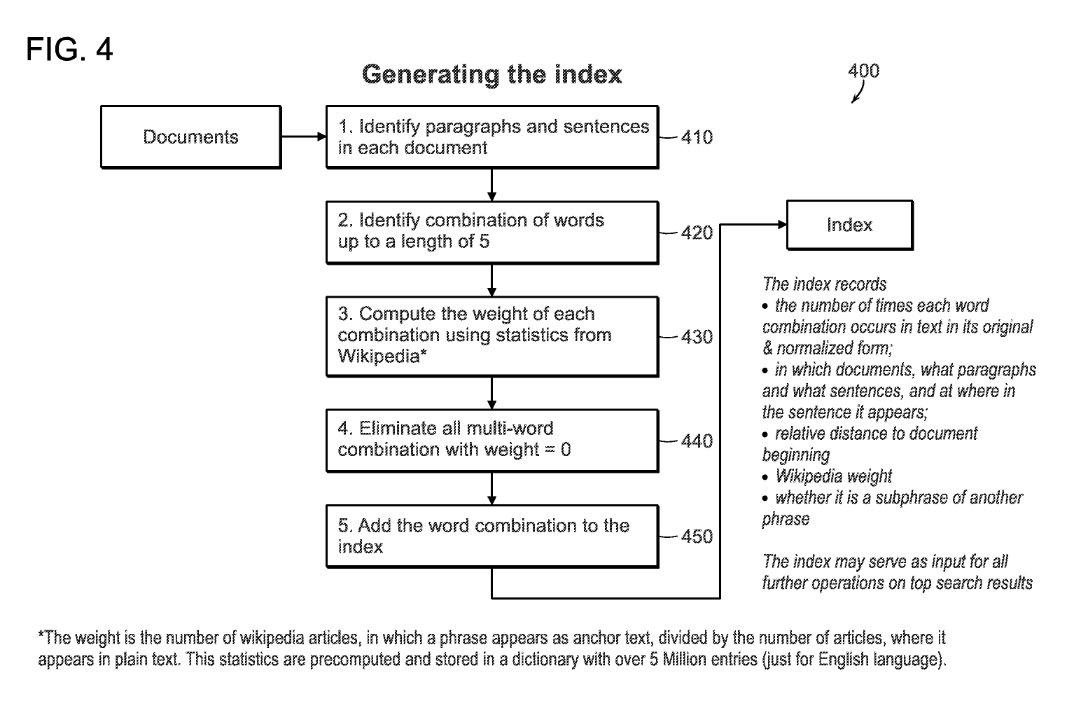

As noted, processing of the returned results to determine query variations includes, in some embodiments, generating an index of word combinations from data referenced by the selected subset of search results (e.g., documents corresponding to the search results), and determining variations of the search query submitted. With reference to FIG. 4, a flow diagram of a procedure 400 to generate an index of word combinations from data referenced by the search results is shown. In some implementations, the data is references through HTML links or other types of links (i.e., links to the set of files corresponding to the search results). Thus, initially, the data of the referenced files/data sources may need to be converted to a format suitable to generate the word combination index, e.g., a text format. Such data conversion of the data maintained by the references files/data sources may be performed, for example, using Microsoft™ iFilter technology, or some other application configured to perform formatting conversions. With the data of the files/data sources accessed (and/or converted to a suitable format), paragraphs and sentences within each of the data sources (e.g., documents) referenced by the search results are identified 410. Identifying such paragraphs and sentences (e.g., to identify the boundaries of sentences and paragraphs) may be based on analyzing the documents' text with respect to a set of predefined heuristics, which specify what context determines the boundary of a sentence or a paragraph.

Having identified paragraphs and sentences within the referenced data sources (e.g., documents), word combinations appearing within the paragraphs/sentences are identified 420. In some embodiments, the length of word combinations considered may be limited by some pre-determined maximum combination length (e.g., 5 words, 10 words, etc.).

In some embodiments, the identification of word combinations may include, for example, applying a sliding window approach, where the window size may vary from one word to the pre-determined maximum combination length, e.g. five words. For example, for a sentence such as “car manufacture is an important part of US Economy”, the sliding window may extract the word combinations:
“car manufacture is an important”;
“car manufacture is an”;
“car manufacture is”; “car manufacture”;
“car”;
“manufacture is an important part”;
“manufacture is an important”;
“manufacture is an”;
“part of US Economy”;
“of US Economy”;
“US Economy”; and/or
“Economy.”

Subsequently, a determination is made as which word combinations are to be added to the index and which word combinations are to be discarded.

Thus, after word combinations appearing in paragraphs and sentences of the referenced data sources have been identified, a metric, such as a weight, is computed 430 for each combination to enable identifying contextually important, or relevant, word combinations and/or eliminate word combinations that, based on the computed metric/weight, are deemed to be not important/relevant or are determined to be phrases which do not represent concepts, e.g. both “car” and “car manufacture” will receive a sufficiently high weight to be included, whereas “car manufacture is” will receive a weight of zero and will be eliminated.

In some implementations, computing weights for word combinations may be based, for example, an occurrence of the word combinations (the same combination or similar combinations) in various public data repositories whose content is representative of relevance of word combinations identified at 420. In some implementations, the weights computed for the identified word combinations may be based on data content of a data repository such as, for example, Wikipedia™ and/or statistics determined for the content of such data repository. For example, weights for the word combinations identified through operation of the procedure 400 may be computed by determining the number of Wikipedia articles in which a particular word combination appears as an anchor text (i.e., text presented as a clickable hyperlink, and/or, in some embodiments, text occurring in prominent parts of the document, such as in headings, the abstract, etc.), and dividing that determined number of anchor text occurrences with the number of other occurrences of the word combination in the article (i.e., in plain text). Generally, word combinations appearing as anchor text are considered to be valid phrases representing concepts and are thus accorded a significant weight.

In some embodiments, statistics for various word combinations appearing in the data repository used to compute weights may have been pre-computed. For example, Wikipedia™ can be used to compute word combination statistics for a large number of entries (i.e., the content of a public repository such as Wikipedia™ may be used to determine/extract required statistics). Thus, in some embodiments, the pre-compiled dictionary for the data repository of choice may first be searched to determine if a particular word combinations identified in 420 is stored in the dictionary, and if so, the weight statistics for that particular word combination is either retrieved, or derived from information maintained for that word combination in the dictionary. If the particular word combination (word or phrase) is not maintained in the dictionary, the procedure 400 may determine the weight for that word or phrase to be zero.

In some embodiments, where a weight for a particular word combination is determined to be below some predetermined threshold (e.g., 0.9, 0.5, 0.2, 0.1, 0.05 or lower), the weight for that word combination is set to 0. Other methods/techniques for computing weights for identified word combinations may be used.

After computing weights for the word combinations identified from the data of the returned search results, word combination associated with computed weights that are equal to or are below a particular pre-determined value may be excluded or eliminated 440 from further processing to generate the index. For example, word combinations with a computed weight of 0 may be excluded from further index generation processing. The remaining (i.e., non-excluded) word combinations whose associated weights exceeded the particular pre-determined threshold are added 450 to the index. Alternatively, if an entry for the particular word combination in the index already exists, that entry is updated with the information pertaining to the particular word combination.

The index generated and maintained for word combinations may record one or more of the following information:
The number of times each word combination occurs, in its original and/or its normalized form, in the data corresponding to the returned search results;
The data sources (e.g., documents), paragraphs and sentences in those sources, and location in the sentences, where a word combination appears;
Relative distance of a word combination to the beginning of the data source. In some implementation, the relative distance is determined for the earliest word combination within the word combinations assigned to a given index entry. In other words, the relative distance is computed once per index entry, and the distance of the word closest to the beginning of the data source is recorded;
The weight computed for the word combination (which may match the Wikipedia weight); and
Whether the word combination is a sub-phrase of another phrase, e.g., the word “car” may be determined to be a sub-phrase of “car manufacture,” whereas “car manufacture” may be determined, in this example, not to be a sub-phrase.
   Other types of information pertaining to word combinations may also be recorded in the index entries for those word combinations. Thus, the resulting index includes index entries, with each entry containing a set of one or more equivalent word combinations. For each word combination information about its occurrences in the original document may be recorded.

In some embodiments, index generation/processing may also include normalization (used, for example, to conflate the occurrences of the same concept in different variations to a unique index entry). Word combinations may be normalized so as to put the various combinations in, for example, lower case. Optionally, some pre-defined words may be removed from word combinations (such pre-defined words are also called stopwords, and include highly frequent words like “the”, “such”, “accordingly”). The remaining words may be sorted alphabetically. Such operations enable mapping phrases like “economy of US” and “US economy” to the same index entry. Another example of a normalization operation is that when a word combination includes a possessive ending, e.g. “'s”, it is removed from the combination. Normalization process may also include identifying a synonymous/equivalent entries for a given word combination. For example, “NYC” may be added to the index entry for “New York”, if their synonymy is recorded in a dictionary (such as the dictionary accessed at 450 of the procedure 400). Such a dictionary may be automatically constructed by analyzing Wikipedia's redirect information, or any other available sources.

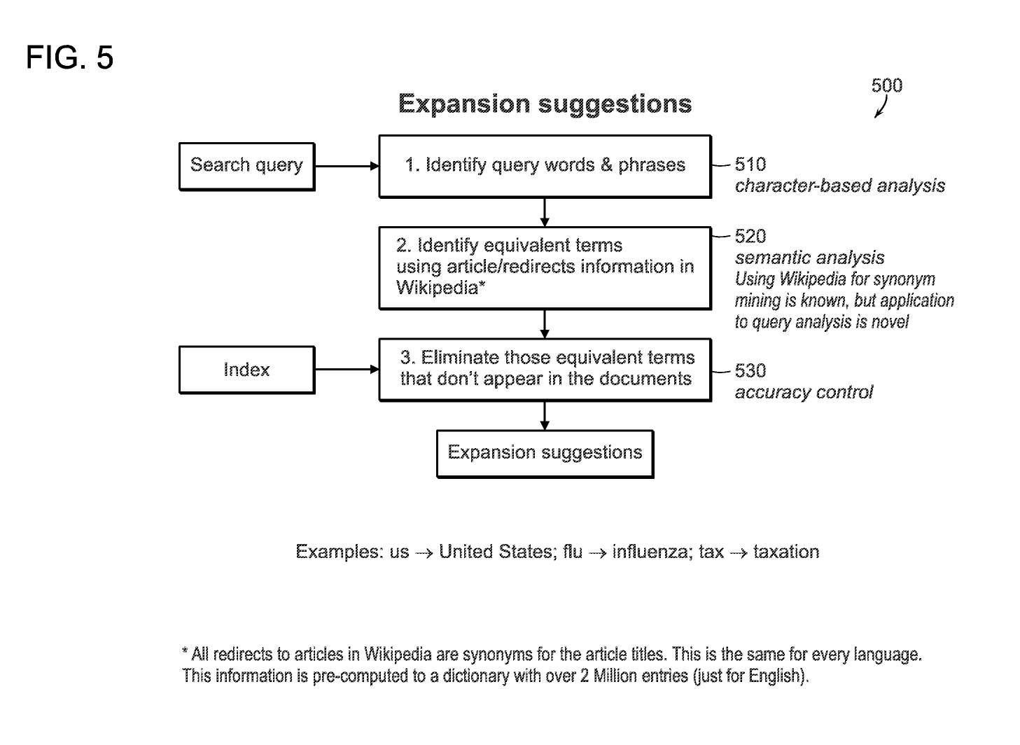

Based on the index of word combinations and/or the search query submitted at the beginning of the current iteration, the application 100 can determine variations of that search query that may yield better quality and/or more relevant search results. For example, as noted above, in some embodiments, determining variations of the search query includes determining possible expansions of the search query. With reference to FIG. 5, a flow diagram of an example procedure 500 to determine expansion suggestions is shown. In some embodiments, determination of the expansion suggestions is based, at least in part, on the just-submitted search query. Thus, the search query submitted is processed to identify 510 query words and phrases comprising the just-completed search query. Identification of the constituent query words and phrases may be performed as a character-based analysis (e.g., parsing the search query to individual components). Character-based analysis may also include determining how the query itself is structured. For example, a quotation mark may indicate the beginning or end of a phrase, a white space in the query may indicate existence of separate words, a minus sign (i.e., “−”) in the query may indicate an excluded term, etc.

The identified words and phrases comprising the search query may then be used to identify 520 equivalent terms and phrases using, for example, popular public data repositories such as, for example, Wikipedia™, although other repositories may be used as well. For example, Wikipedia™ maintains a pre-computed dictionary of articles and their respective associated redirects (e.g., links to other data items that may be associated with the words/phrases identified at 510). For example, Wikipedia™ uses redirect pages to link to articles, whose titles have equivalent meaning. Wikipedia's data relating to articles and redirects may thus be mined to create a data repository of equivalent terms/and synonyms. Other procedures to identify equivalent terms from Wikipedia™ or some other data repository (private or public) may also be used.

Thus, the identified query words and phrases may be compared to article titles, and/or other information, and the articles' redirects to identify equivalent terms. For example, if a query term includes the word “flu”, or “H1N1,” a comparison of a dictionary of articles and redirects may identify a redirect entry associated with “flu” that points to, or is associated with, an article for the word “influenza.” In this situation, an expansion suggestion might therefore be to use the term “influenza” in addition to the word flu used in the previous query iteration. Similarly, the terms “United States” and “taxation” may be identified, through a search of a repository's dictionary of articles and redirects, as the equivalents of the query words “US” and “tax,” respectively. Thus, identification of equivalent terms is a form of a semantic analysis in which identification of terms that may have similar meanings to the query words is performed. In some implementations, the identification of equivalent terms may also be based on other types of semantic analysis procedures, including, for example, other types of natural language processing, etc.

In some implementations, after identifying equivalent terms, those equivalent terms that do not appear in the data sources (e.g., documents) returned in the search results corresponding to the current search query may be eliminated 530 from further consideration. To determine if the equivalent terms identified at 520 appear in the documents of the returned search results, the index of word combinations may be searched. If a particular identified equivalent term (identified at 520 based on a semantic analysis) is not found in the index of word combinations that equivalent term is not presented, in some embodiments, as a possible query expansion. In some implementations, when a word combination from a query is mapped to an index entry, one, some or all of the others terms (if any exist) that are associated with that entry, including equivalent terms already mapped to the particular index entry, may be used as expansion suggestions.

Once equivalent terms are determined to appear in the documents corresponding to the returned search results, those equivalent terms may be presented as expansion suggestions in a dashboard such as the dashboard 200 shown in FIG. 2A.

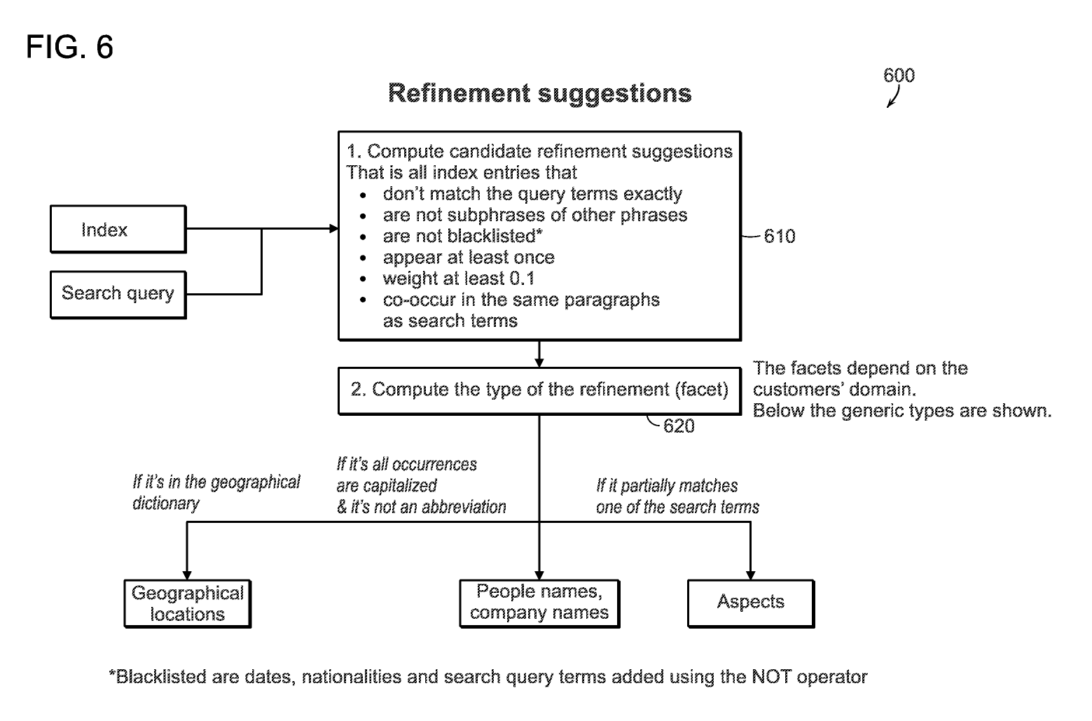

Another type of search query variation includes query refinements of the current search query. In some embodiments, the query refinement suggestions may supplement expansion suggestions, and cover possible query variations that were not determined through expansion suggestions processing (e.g., in a manner similar to the procedure depicted in FIG. 5). FIG. 6 illustrates a flow diagram of an example refinement suggestions procedure 600. As shown, the procedure 600 includes determining 610 candidate refinement suggestions based, at least in part, on the index of word combinations and the search query. In some implementations, determination of the refinement suggestions may be performed by searching the index of word combinations according to an applied set of rules regarding the type of word combinations in the index that may be determined as possible refinements of the current search query. For example, and as shown in FIG. 6, word combinations identified as possible refinement suggestions may be required to satisfy one or more of the following rules:
The identified word combinations do not match the query words;
The identified word combinations are not sub-phrases of other phrases;
The identified word combinations are not included in a list of “blacklisted” word combinations. Examples of blacklisted word combinations that should not be selected as possible refinement suggestions include, in some embodiments, dates, nationalities, search query terms that were added using a “NOT” logical operator, etc.;
The identified word combinations appear at least once (and above some predetermined threshold);
The identified word combinations have associated weights (e.g., computed based on occurrence as anchor words and occurrence in plain text) that are at least equal to some pre-determined weight threshold (e.g., greater than or equal to 0.1);
The identified word combinations occur in paragraphs in which search words/terms in the current query appear.
   Additional or fewer rules to determine possible refinement suggestions may be applied.

In some embodiments, to facilitate the refinement of the current search query, word combinations identified as possible refinement suggestions may be further classified into one or more facets (or categories). Examples of facets into which candidate refinement suggestions may be classified include geographical locations, people and/or company names, general or domain-specific subject matter categories, etc. In some implementations, if a word combination does not fit into any of the pre-defined categories, but parts of the word combination match one more query terms, e.g. “world economy” for a query term “economy,” such a combination may then be categorized as an “aspect” of a query.

Thus, and as shown in FIG. 6, the procedure 600 may also include computing/determining 620 the type (also referred to as class, category, or facet) of the candidate refinement suggestions. In some implementations, determination of the facets of the candidate refinement suggestions may be based on application of one or more rules and/or other types of processing. For example, to classify candidate refinement suggestions into a geographical locations facet, a determination is made as to whether a particular candidate refinement suggestion (identified, for example, at 610 of FIG. 6) is found in some geographic dictionary (maintained locally or remotely from the server executing the application 100 of FIG. 1). In another example, a candidate refinement suggestion may be classified into a names facet upon a determination that most occurrences (e.g., in the index of word combination) of the candidate refinement suggestion are capitalized, and that the candidate refinement suggestion is not an abbreviation or acronym (as may be determined based on a search for that candidate in an abbreviation/acronym dictionary). In a further example, a candidate refinement suggestion may be classified into a general aspect facet upon a determination that the candidate refinement suggestion partially matches one of the search terms/words of the current query.

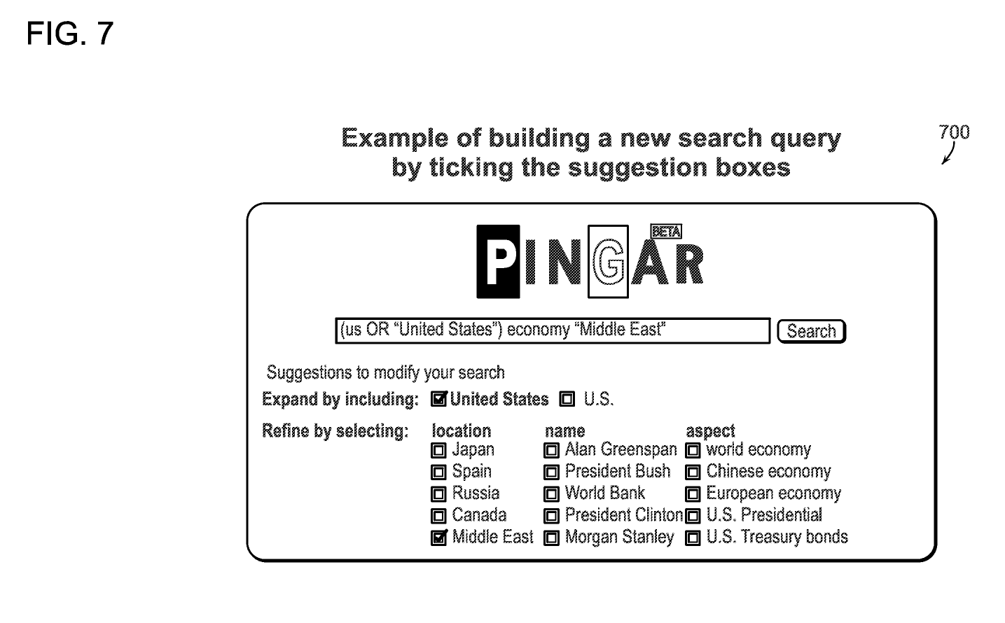

With reference to FIG. 7, an example dashboard 700 illustrating operation of the procedures 500 and 600 to determine possible expansion suggestions and refinement suggestions is shown. The example illustrated in FIG. 7 includes possible expansion and refinement suggestions resulting from the processing of search results returned through submission (e.g., via the Pingar™ interface) of the search query “us economy.” As previously noted, the search query may have been entered through the Pingar interface and communicated to one or more search engines, such as Google™, Bing™, Yahoo™, etc., with which a universal search engine application, such as the application 100, communicates. A subset of the results returned is processed to generate (or, in some embodiments, update) a word combinations index corresponding to word combinations found in the data sources (e.g., documents) corresponding to subset of the returned search results.

As described herein, to determine possible expansions, in some embodiments, the words/phrases comprising the search query are identified, equivalents of those words/phrases are identified, and a determination is made whether the identified equivalents occur within the index of word combinations. Thus, in the example of FIG. 7, the equivalent terms “United States” and “U.S.” were identified and are presented on a dashboard. In some embodiments, the user may select which, if any, of the expansion suggestions it may wish to use (e.g., by checking a selection box appearing in the dashboard). In some embodiments, selection of expansion suggestions may be performed automatically, e.g., by using a learning engine implemented, for example, using a neural net or some other arrangement suitable to implement a learning engine, by identifying the expansion suggestions (e.g., in a manner as described above), automatically adding them to a refined search query, and re-submitting the refined query to the search engine (user would then be presented with results of the automatically added expansions). Other procedures/ways to select expansion suggestions (automatically and/or manually) may also be implemented.

To determine refinement suggestions, for example, by applying the procedure 600 of FIG. 6, candidate refinement suggestions that meet one or more requirements are identified, and may then be classified into one or more facets. In the example, of FIG. 7, candidate refinement suggestions include, under the geographic Location facet, the candidates “Japan,” “Spain,” “Russia,” “Canada,” and “Middle East.” Any of these candidates may have been identified is those candidates satisfied requirements/rules such as those listed in FIG. 6. For example, the candidate “Japan” may have been identified because the word did not match the query terms (which are “us” and “economy”), it did not match a sub-phrase of another phrase, it was not blacklisted, it may have appeared at least once in the generated index of word combinations, it may have had a weight of at least 0.1, and it may have occurred in a paragraph where one of the search term of the query appeared. Additionally, the candidate refinement suggestion “Japan” may have been placed into the Geographical Locations facet because the word “Japan” appeared in a geographical dictionary.

As further shown in FIG. 7, the user selected the expansion suggestion “United States” and the refinement suggestion “Middle East,” resulting in a refined query of “(us OR ‘United States’) economy ‘Middle East’.” This way, by selecting/clicking a couple of check boxes, the user can build a complex Boolean search query (Boolean queries generally can be easily interpreted by search engines, but may be hard to formulate by people. The refined query may subsequently be submitted to the same (or another) search engine with which the application 100 interfaces and interacts to obtain the next iteration of returned search results that may be more refined, of better quality, and/or of higher relevance than the search results obtained in the preceding iteration.

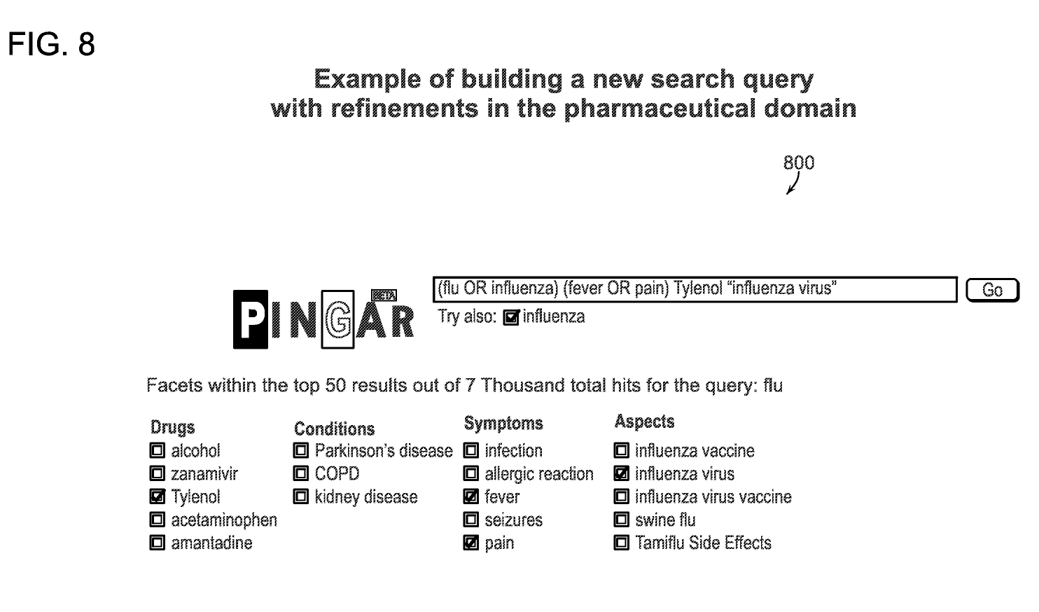

In some embodiments, the facets used to classify candidate refinement suggestions may be specific to the general subject matter area corresponding to the current search query, the index of word combinations, or the refinements suggestions. For example, and with reference to FIG. 8, a screenshot of an example dashboard 800 providing query variations and enabling determination of a refined search query is shown. In the example of FIG. 8 an initial search query of “flu” was performed. As shown, the refinement suggestions were classified into four facets related to pharmaceutical and/or health domain. The four illustrated facets into which the candidate refinement suggestions were classified include Drugs (e.g., zanamivir, Tylenol), Conditions (e.g., kidney disease, COPD), Symptoms (e.g., infection, fever), and Aspects (influenza vaccine, influenza virus). Other facets could also have been used. A user presented with the possible variations (expansion suggestions and refinement suggestions) can thus interact with the dashboard to enable generation of a new refined query, which in the example of FIG. 8 is “(flu OR influenza) (fever OR pain) Tylenol ‘influenza virus’.” As further shown in FIG. 8, the dashboard may have a layout and/or features that are unique to the particular subject matter area associated with the initial query and returned results. Thus, the dashboard 800 of FIG. 8 includes, for example, a graphic presentation of a molecule model.

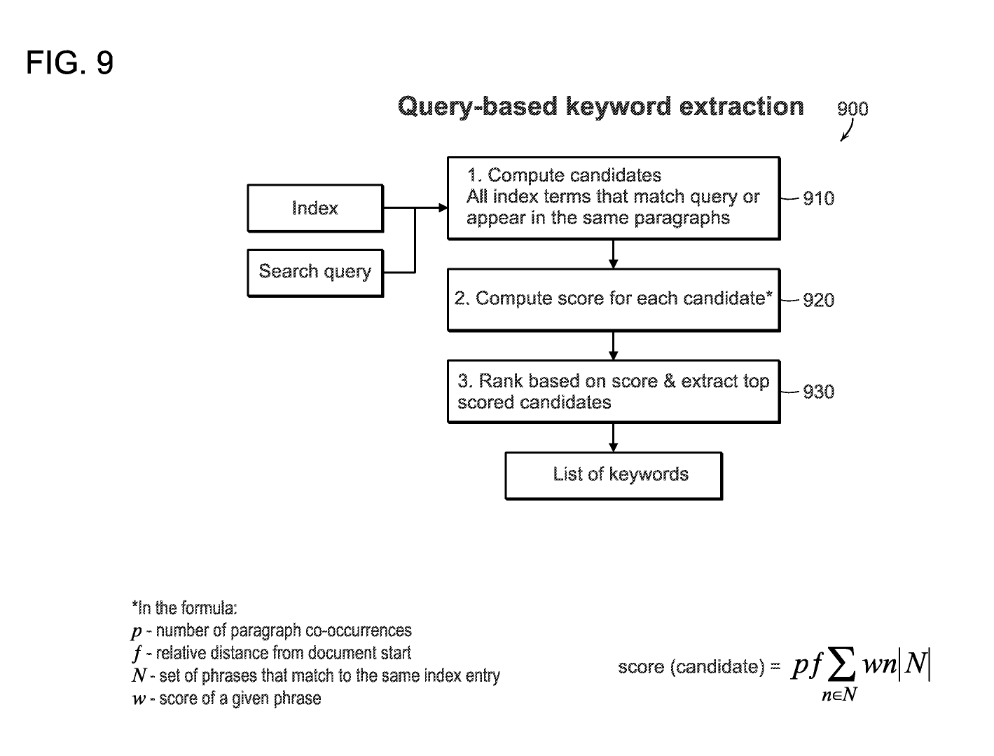

With reference again to FIG. 2A, as noted, the dashboard 200 includes a preview area providing data in relation to the data sources (documents) referenced by the search results, including, in some implementations, key words and sentences or paragraphs deemed to represent/summarize the data sources corresponding to the returned results. FIG. 9 illustrates a flow diagram of an example procedure 900 to extract keywords, for at least one of the referenced data sources. As shown, in some implementations candidate keyword are determined 910 based on the generated index of word combinations and/or the search query. For example, to determine the keywords in a document, some (or all) of the index entries (e.g., word combinations with equivalent meaning) that match the terms of the query and/or index entries that appear in the same paragraphs where query terms appear are identified.

Having determined the candidate keywords, a score or metric is computed 920 for each of the candidate keywords. In some embodiments, a representative score for the candidate keywords may be computed based on the formulation:

$$score ( candidate ) = pf {\sum }_{n ∈ N}^{ } wn \vert N \vert$$

where p is number of paragraphs in which there is a co-occurrence of the particular candidate and one or more of the query terms, f is the relative distance of the candidate keyword from the beginning of the data source (e.g., the document), N is a set of equivalent word combinations stored in the index entry corresponding to the candidate, and w is the score given to a phrase. Other formulations to compute a score for the various candidates may be used in addition to or instead of the above formulation.

After the scores for the keyword candidates are computed, the scores, and thus the candidates, are ranked 930. A pre-determined number (e.g., 1, 2, 5, 10, or any other number) of the candidates with the highest scores are then selected (also at 930) and are presented in the preview area. As shown in FIG. 2, in some embodiments, the top five keywords are presented, e.g., in bold letters, and separated by commas. For example, item 250 in FIG. 2 includes the determined top five keywords of the second listed document of the returned search results.

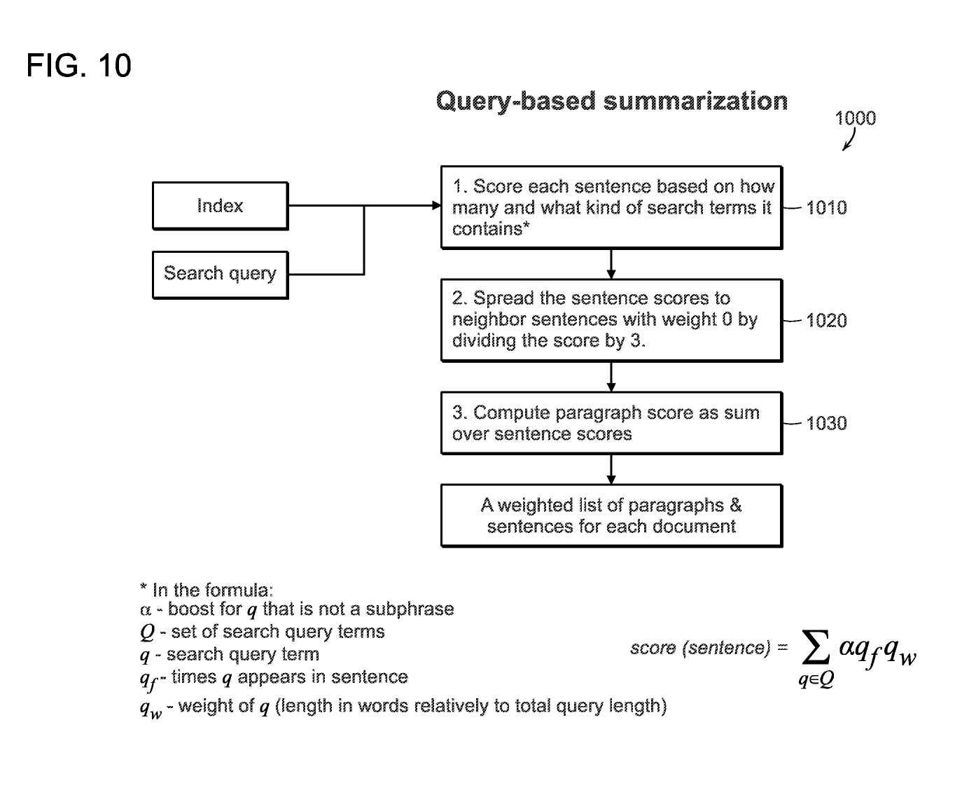

With reference to FIG. 10, a flow diagram of an example procedure 1000 to identify the paragraph(s) and/or sentence(s) that are deemed to best represent the document corresponding to one of the returned search results is shown. Paragraphs and/or sentences representative of the document of the search results may be determined based, at least in part, on the generated index of word combinations and/or the search query. Thus, for example, as depicted in FIG. 10, each sentence in a particular document may be scored 1010 based on which of the query terms appear in the sentence and how many times those query terms appear in that sentence. In some embodiments, a representative score for a candidate sentence may be computed based on the formulation:

$$score ( sentence ) = {\sum }_{q ∈ Q}^{ } α {q}_{f} {q}_{w}$$

where q is a query term, q_{f} is the number of times the query term q appeared in the sentence being scored, q_{w} is the weight of the query term q (which, in some embodiments, may be the length, in words, relative to the length of the entire search query), Q represents the set of search query terms, and α is a boost coefficient to increase the score when the search term q is not part of a phrase.

In some implementations, the score of a particular sentence may be increased when the sentences is located next to neighboring sentences that received a non-zero score. For example, in some embodiments, the non-zero score of a sentence is spread 1020 to its neighboring sentences by assigning each of the neighboring sentences (e.g., a preceding, a succeeding, or preceding and succeeding if both exist) a score based on sentence with the non-zero score. For example, consider a paragraph (“Paragraph A”) that includes two sentences with one of the sentences having a score of 3. In this example, the second sentence may receive a score of 1.5. In another example, another paragraph (“Paragraph B”) has three sentences, with the middle sentence having a score of 3. In this example, the first and the last sentences may each receive a score of 1.5. As a result, Paragraph B will have a higher score, and thus may be ranked higher than Paragraph A.

Having computed the scores of sentences in a particular document, the scores of the document's paragraphs are computed 1030 by, for example, computing the sum of the scores of the sentences in each of the document's paragraphs. The paragraph with the highest score may then be selected and presented in the preview area 240 shown in FIG. 2. For example, item 260 in FIG. 2A includes a portion of the high-scoring paragraph for the particular document. The resultant scores computed using the procedure 1000 provide information about the weights that paragraphs and sentences receive, which are subsequently used to select the previewed sentence/paragraph (e.g., in the preview area 240 of the dashboard 200) and/or to generate a summary for a search report.

With reference again to FIG. 1, the application 100 also includes report generation processing 150 to generate a search report based on the processed search results returned. Such a search report may be generated after any iteration involving submission of a query, or may be generated at the conclusion of the iterative process, e.g., after the user has decided and provided indication that no further iterations are necessary. As noted, in some embodiments, the iterative processing may automatically conclude after a pre-determined number of iterations has been performed, after a computed metric representative of the quality and relevance of the search results has achieved a pre-determined values, etc. Generation of a search report may include, in some embodiments, generating a personalized PDF report containing search results for a particular query, condensing each search result to a pre-determined number of the most relevant paragraphs of the corresponding document (and optionally includes a link to the full document/data source), creating a dynamic table of contents, and/or assigning user permission/authorization levels to the generated report.

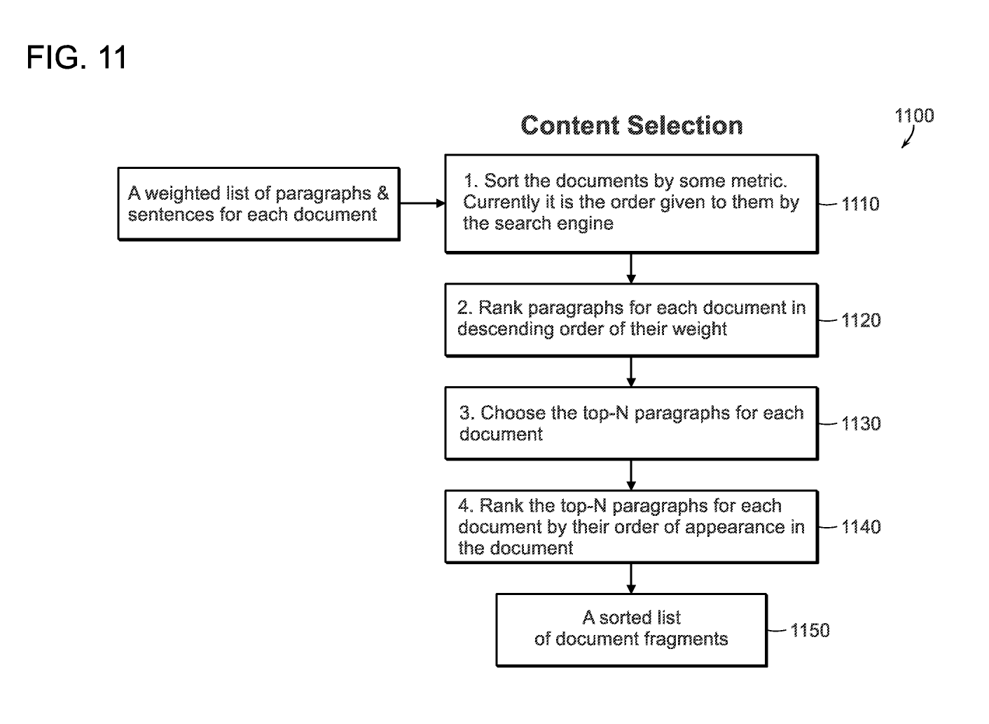

With reference to FIG. 11, a flow diagram of an example procedure 1100 to select content to be used for generating search reports is shown. As illustrated, the various documents/data sources corresponding to the search results are sorted 1110 based on some metric computed for each of the documents/data sources (prior to performing ranking operations, the search results and/or their corresponding documents/data sources may be presented in whatever order was determined by the at least one search engine to which the query was submitted). The determination of metrics for each of the documents may be based on scores/metrics computed, for example, during the procedure to determine representative sentences/paragraphs of each of the documents (e.g., a procedure such as the procedure 1000 depicted in FIG. 10). In some embodiments, the ranking of the documents is based on the ranking identified by the search engine(s) used.

The procedure 1100 may also include, in some implementations, ranking 1120 paragraphs for each of the documents corresponding to the search results. The ranking operation may be based on the scores computed, for example, in the performance of the procedure 1000 of FIG. 10. In some embodiments, the paragraphs of each document may be ranked, for example, in descending or ascending orders according to their weights, or according to some other order. As further shown in FIG. 11, in some embodiments, a pre-determined number of paragraphs for each document (e.g., the top N paragraphs) may be selected 1130 for inclusion with the search report to be generated. Additionally, in some embodiments, the selected pre-determined number of paragraphs may be ranked 1140 according to their order of appearance in the document. Accordingly, the procedure 1100 may include determining the top paragraphs (e.g., in terms of their weight or relevance) and then restoring the determined top paragraphs to their original relative positions in the document with respect to each other, thus providing 1150 a sorted list of document fragments.

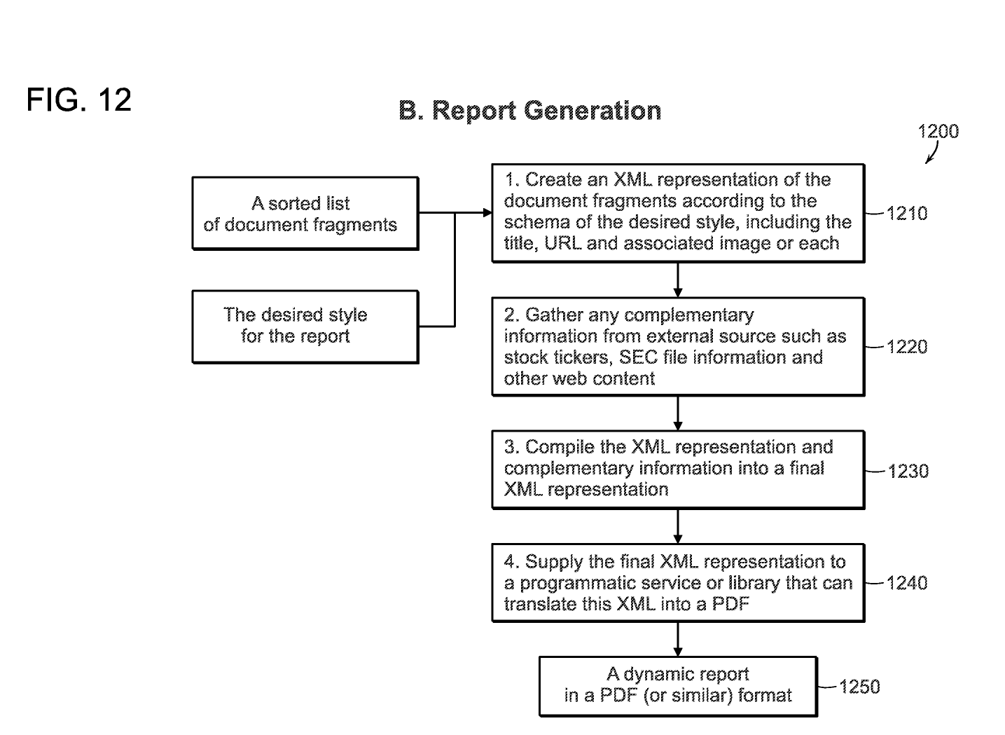

Having determined the content to be included in a search report, the search report may subsequently be generated. With reference to FIG. 12, a flow diagram of an example report generation procedure 1200 is shown. The search report to be prepared may be generated based on the sorted list of document fragment (such as the list provided through the procedure 1100 depicted in FIG. 11), and information about the style and formatting according to which the report should be generated. Information about the report style, formatting, and other attributes may be provided, for example, by the user, or may be set at some earlier time instance by an administrator or technician. Such information may be recorded as a schema. Thus, as shown in FIG. 12, using the sorted list of document fragments, an Extensible Markup Language (XML) document may first be generated 1210 according to a schema of the desired style. The XML document may include a report title, URL's pointing to the actual documents from which some of the content of the report was extracted, associated images, etc.

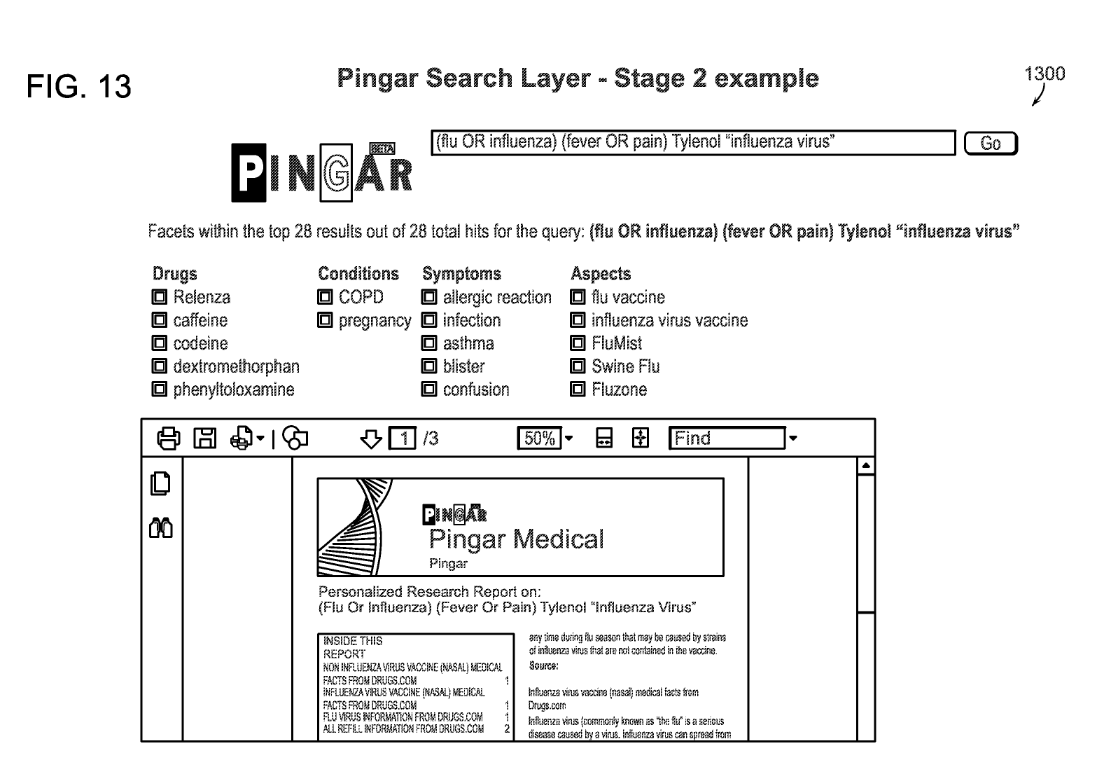

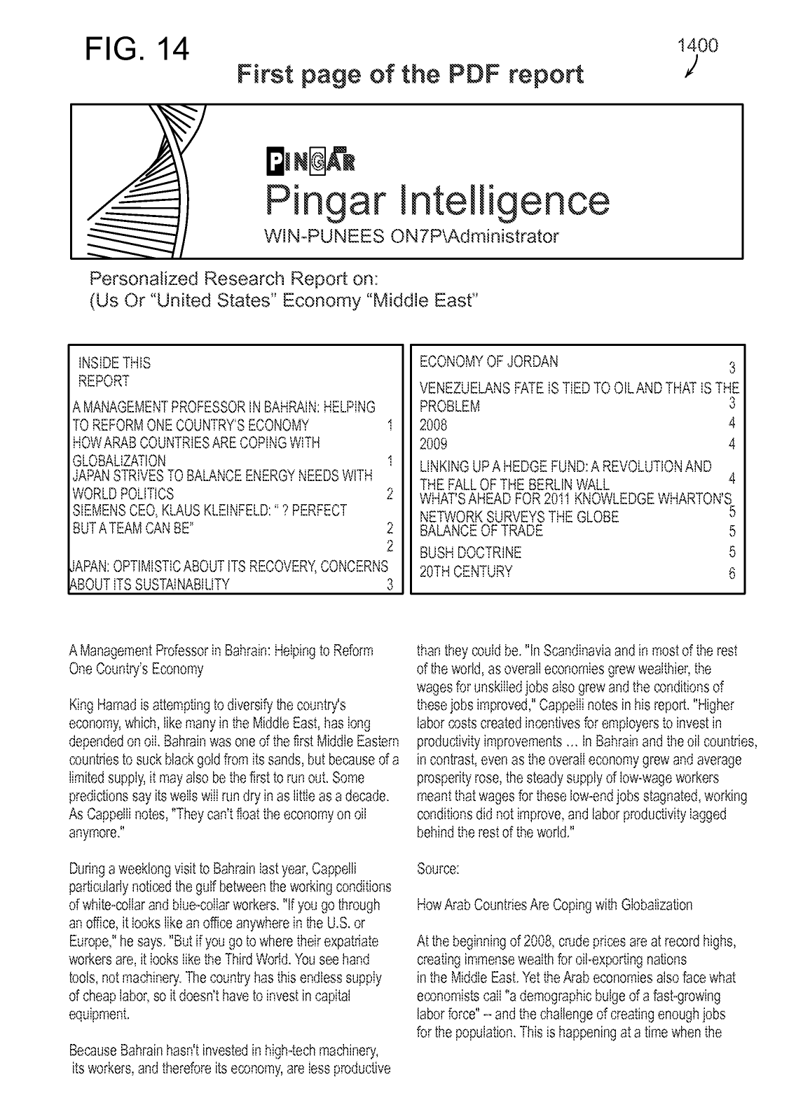

In some implementations, complementary information from external sources (e.g., stock tickers, SEC file information, other accessible sources of content) is collected 1220 so that some of that information can be included in the report. The XML representation of the report is then compiled 1230, with or without any collected complementary information, into a final XML representation. Subsequently, the final XML document is processed to produce 1240 a corresponding recordable and accessible document, e.g., a PDF document. In some implementations, the XML representation of the search report may be converted to its recordable format (e.g., PDF) using commercially available or custom-made conversion applications. The converted recordable document is thus provided 1250. FIG. 13 is a screenshot of an example PDF search report 1300, presented on a dashboard such as the dashboard 200, corresponding to the search results for the query “(flu OR influenza) (fever OR pain) Tylenol ‘influenza virus’.” FIG. 14 is a screenshot of a first page of an example search report 1400 corresponding to the query “(us OR ‘United States’) economy ‘Middle East’.”

The personalized generated search report may subsequently be recorded (with any assigned access permission/authorization levels) in data repositories so that it can be accessed and retrieved in the future by any one of multiple users having the proper authorization level needed to access the report. For example, and as illustrated in FIG. 3, in some embodiments, generated search reports may be recorded in a data repository such as, for example, Microsoft's SharePoint™. As shown in the figure, the SharePoint interface may be configured to install features of the interface of the application 100 with which a user may interact to submit and refine queries and record search reports.

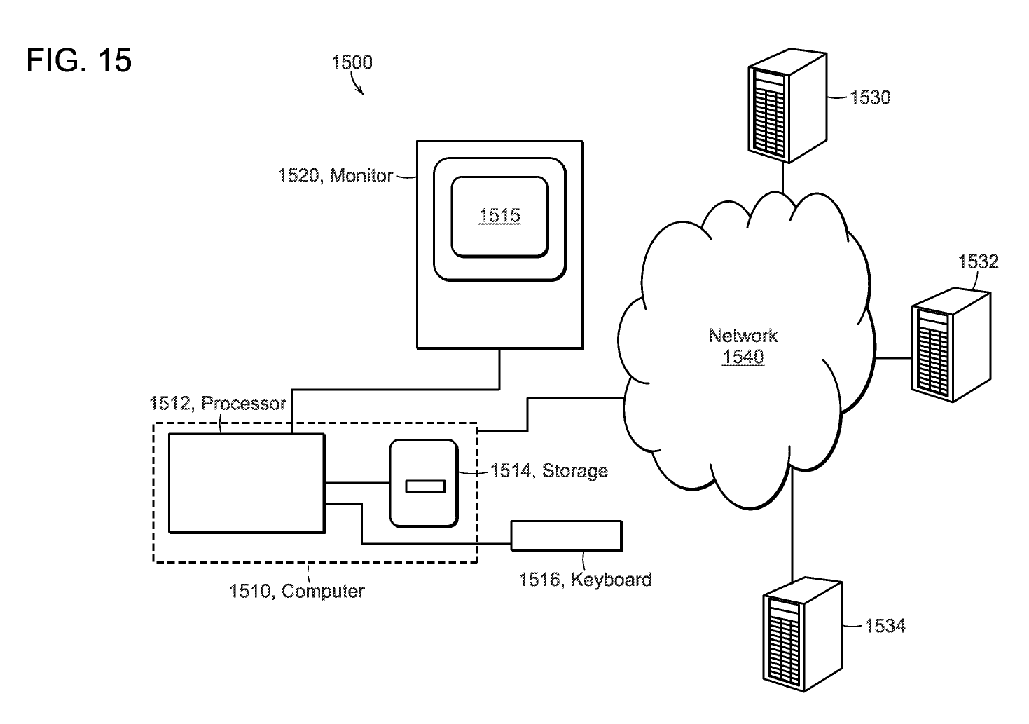

With reference to FIG. 15, a schematic diagram of an example embodiment of a computer-based system 1500 on which a universal search engine application, such as the application 100 of FIG. 1 may be implemented, is shown. The system 1500 includes at least one computing-based device 1510 such as a personal computer (e.g., a Windows-based machine, a Mac-based machine, a Unix-based machine, etc.), a personal digital assistant, a specialized computing device, and so forth, that typically includes a processor 1512 (e.g., CPU, MCU). In some embodiments, the computing-based device may be implemented in full, or partly, using an iPhone™, an iPad™, a Blackberry™, or some other portable device (e.g., a smart phone device), that can be carried by a user, and which may be configured to perform remote communication functions using, for example, wireless communication links (including links established using various technologies and/or protocols, e.g., Bluetooth, Wi-Fi, 3G, etc.) In addition to the processor 1512, the system includes at least one memory (e.g., main memory, cache memory and bus interface circuits (not shown)). The computing-based device 1510 can include a storage device 1514 (e.g., mass storage device). The storage device 1514 may be, for example, a hard drive associated with personal computer systems, flash drives, remote storage devices, etc.

Content processed and/or generated by the system 1500 may be presented on a multimedia presentation (display) device 1520, e.g., a CRT (cathode ray tube) or LCD (liquid crystal display) monitor, a plasma monitor, etc. Other modules that may be included with the system 1500 are speakers and a sound card (used in conjunction with the display device to constitute the user output interface). A user interface 1515 may be implemented using the multimedia presentation (display) device 1520 to present data including data to enable refinement of search query, data relating to search results corresponding to a currently submitted query, etc. In some embodiments, the system 1500 may also include user input interfaces such as a keyboard 1516, and a pointing device, e.g., a mouse, a trackball (used in conjunction with the keyboard to constitute the user input interface), a stylus, etc. In some embodiments, the user interface 1515 may comprise touch-based GUI by which the user can provide input.

In some embodiments, the system 1500 is configured to, when executing on the at least one computing-based device, computer instructions stored on a memory storage device (for example) or some other non-transitory computer readable medium, implement an application to submit queries to at least one of a plurality of search engines whose own respective interfaces are not presented, receive and process data relating to search results to determine possible variations for the query, to determine the quality and relevance of returned search results, and to generate search reports.

The at least one computing-based device may further include peripheral devices to enable input/output functionality. Such peripheral devices include, for example, a CD-ROM drive, a flash drive, or a network connection, for downloading related content to the connected system. Such peripheral devices may also be used for downloading software containing computer instructions to enable general operation of the respective system/device, as well as to enable submission of queries to remotely operating search engines, and receipt and processing of search results corresponding to the submitted queries to determine the quality and relevance of the returned results, present relevant portions of returned search results, determine variations of the query (e.g., determine possible expansion and refinement suggestions for the current query), and to generate search reports.

In some embodiments, special purpose logic circuitry, e.g., an FPGA (field programmable gate array) or an ASIC (application-specific integrated circuit) may be used in the implementation of the system 1500. The at least one computing-based device 1510 may include an operating system, e.g., Windows XP® Microsoft Corporation operating system. Alternatively, other operating systems could be used. Additionally and/or alternatively, one or more of the procedures performed by the system may be implemented using processing hardware such as digital signal processors (DSP), field programmable gate arrays (FPGA), mixed-signal integrated circuits, etc. In some embodiments, the computing-based device 1510 may be implemented using multiple inter-connected servers (including front-end servers and load-balancing servers) configured to store information pulled-down, or retrieved, from remote data repositories hosting content that is to be presented on the user interface 1515.

The various systems and devices constituting the system 1500 may be connected using conventional network arrangements. For example, the various systems and devices of system 1500 may constitute part of a public (e.g., the Internet) and/or private packet-based network. Other types of network communication protocols may also be used to communicate between the various systems and devices. Alternatively, the systems and devices may each be connected to network gateways that enable communication via a public network such as the Internet. Network communication links between the components and devices of system 1500 may be implemented using wireless or wire-based links. For example, in some embodiments, the system may include communication apparatus (e.g., an antenna, a satellite transmitter, a transceiver such as a network gateway portal connected to a network, etc.) to transmit and receive data signals. Further, dedicated physical communication links, such as communication trunks may be used. Some of the various systems described herein may be housed on a single computing-based device (e.g., a server) configured to simultaneously execute several applications. The computing-based device 1510 on which an application, such as the application 100 of FIG. 1, may be executing, may submit queries to search engines operating on one or more remote servers, which then determine search results based on data accessed from other remote servers interconnected through a network 1540. Determined search results may then be communicated back to the computing-based device 1510 via, for example, the network 1540. FIG. 15 depicts three servers 1530, 1532 and 1534 which may host remote search engine applications with which the computing-based device 1510 may communicate and/or may host data used by a remote search engines to determine search results responsive to a query provided by a user through the interface 1515, and communicated to at least one of the plurality of search engines via the network 1540. Additional or fewer servers may be used with the system 1500. As noted, the computing-based device 1510 and the servers 1530, 1532 and 1534 may be interconnected via the network 1540.

The subject matter described herein can be implemented in digital electronic circuitry, in computer software, firmware, hardware, or in combinations of them. The subject matter described herein can be implemented as one or more computer program products, i.e., one or more computer programs tangibly embodied in non-transitory media, e.g., in a machine-readable storage device, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer include a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Media suitable for embodying computer program instructions and data include all forms of volatile (e.g., random access memory) or non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

The subject matter described herein can be implemented in a computing system that includes a back-end component (e.g., a data server), a middleware component (e.g., an application server), or a front-end component (e.g., a client computer having a graphical customer interface or a web browser through which a customer can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other in a logical sense and typically interact through a communication network. The relationship of client and server may arise by virtue of computer programs running on the respective computers and having a client-server relationship to each other.

Although the description herein refers to Pingar™, SharePoint™, Wikipedia™, XML documents, PDF documents, and other such applications and/or mechanisms, these are merely examples of applications and/or mechanisms that may be used with embodiments of the systems, apparatus, methods, and products described herein, and other applications, processing techniques, mechanisms, etc., may be used as well.

A number of implementations of the invention have been described. Nevertheless, it will be understood that various modifications may be made without departing from the spirit and scope of the invention. Accordingly, other embodiments are within the scope of the following claims.

What is claimed is:

1. A method comprising:
receiving, by at least one processor-based device, a search query provided via an interface;
submitting, by the at least one processor-based device, the search query to at least one of a plurality of search engines, each having a dedicated search engine interface, the dedicated search engine interface of the at least one of the plurality of search engines being hidden from view by the interface;
selecting, by the at least one processor-based device, a subset of search results returned by the at least one of the plurality of search engines; and
determining, by the at least one processor-based device, a set of possible query variations based on the selected subset of search results, the set of possible query variations being used to determine one or more refined queries for resubmission to the at least one of the plurality of search engines.

2. The method of claim 1, wherein determining the set of possible query variations comprises:
generating an index of word combinations from referenced data corresponding to the selected subset of search results; and
determining query variations based on the generated index of word combinations

3. The method of claim 2, wherein determining the query variations comprises:
identifying equivalent terms of words comprising the search query; and
determining for one or more of the identified equivalent terms whether the one or more equivalent terms is included in the generated index of word combinations.

4. The method of claim 2, wherein determining the query variations comprises:
identifying, based on the generated index and the search query, one or more terms satisfying one or more specified requirements, the one or more identified terms including terms that at least one of: do not match any portion of the search query, are not sub-phrases of one or more phrases, appear at least once in data referenced by the subset of search results, have a computed weight exceeding a predetermined value, or appear in paragraphs that include at least one of terms of the search query; and
presenting the identified one or more terms as possible query refinements.

5. The method of claim 4, further comprising:
determining one or more subject matter categories associated with the identified one or more terms that are to be presented as possible query refinements.

6. The method of claim 2, further comprising:
determining the one or more refined queries to be submitted to the at least one of the plurality of search engines based on the determined variations of the search query and input received from a user presented with the determined query variations; and
submitting the one or more refined queries to the at least one of the plurality of search engine to generate a further set of search results retuned by the at least one of the plurality of search engines in response to the one or more refined queries.

7. The method of claim 2, wherein generating the index of word combination comprises:
identifying word combinations in the referenced data;
computing a weight for each of the identified word combinations based on statistics associated with content maintained in a public data repository; and
adding the identified word combinations to the index of word combinations.

8. The method of claim 7, further comprising:
normalizing the identified word combinations, the normalizing including one or more of: converting text data of the identified word combinations to one of a lower case and an upper case, discarding words matching pre-defined stopwords, and re-arranging an order of words within the identified word combinations.

9. The method of claim 2, further comprising:
identifying keywords associated with the referenced data associated with each of the returned search results.

10. The method of claim 9, wherein identifying keywords comprises:
identifying from the index of word combinations candidate terms, including terms matching terms of the query, and terms appearing in paragraphs of the referenced data in which the terms of the query appear;
computing a score for each of the candidate terms; and
selecting one or more of the candidate terms based on the computed score for each of the candidate terms.

11. The method of claim 10, wherein computing the score for each of the candidate terms comprises:
computing a score for a particular candidate term based on the formulation:
$$score ( candidate ) = pf {\sum }_{n ∈ N}^{ } wn \vert N \vert$$
where p is number of paragraphs in which there is a co-occurrence of the particular candidate term and one or more of the query terms, f is the relative distance of the candidate keyword from the beginning of the referenced data, N is a set of equivalent word combinations stored in the index entry corresponding to the candidate term, and w is the score given to a phrase from the set of phrases.

12. The method of claim 2, further comprising:
determining a representative paragraph of a document corresponding to the referenced data.

13. The method of claim 10, wherein determining the representative paragraph comprises:
computing a score for each sentence in the referenced data based, at least in part, on how many times one or more of the terms of the query appear in the respective each sentence; and
computing a score for each paragraph of the references data based, at least in part, on the scores of sentences in the each paragraph.

14. The method of claim 13, further comprising:
generating an extensible markup language (XML) document including at least some paragraphs of the referenced data, the paragraphs being ranked according to scores computed for each of the paragraphs;
including complementary data from external resources with the XML document; and
generating a portable document format (PDF) document from the XML document.

15. The method of claim 14, further comprising:
assigning permission parameters to the PDF document to control subsequent access to the PDF document; and
storing the PDF document with the assigned permission parameters in a data repository.

16. The method of claim 15, wherein storing the PDF document in the data repository comprises:
storing the PDF document in a server including one or more web pages.

17. A system comprising:
at least one processor-based device; and
at least one memory storage device coupled to the at least one processor-based device, the at least one memory storage device comprising computer instructions that, when executed on the at least one processor-based device, cause the at least one processor-based device to:
receive a search query provided via an interface;
submit the search query to at least one of a plurality of search engines, each having a dedicated search engine interface, the dedicated search engine interface of the at least one of the plurality of search engines being hidden from view by the interface;
select a subset of search results returned by the at least one of the plurality of search engines; and
determine a set of possible query variations based on the selected subset of search results, the set of possible query variations being used to determine one or more refined queries for resubmission to the at least one of the plurality of search engines.

18. The system of claim 17, wherein the computer instructions that cause the at least one processor-based device to determine the set of possible query variations comprise computer instructions that cause the at least one processor-based device to:
generate an index of word combinations from referenced data corresponding to the selected subset of search results; and
determine query variations based on the generated index of word combinations

19. The system of claim 18, wherein the computer instructions that cause the at least one processor-based device to determine the query variations comprise computer instructions that cause the at least one processor-based device to:
identify equivalent terms of words comprising the search query; and
determine for one or more of the identified equivalent terms whether the one or more equivalent terms is included in the generated index of word combinations.

20. The system of claim 18, wherein the computer instructions that cause the at least one processor-based device to determine the query variations comprise computer instructions that cause the at least one processor-based device to:
identify, based on the generated index and the search query, one or more terms satisfying one or more specified requirements, the one or more identified terms including terms that at least one of: do not match any portion of the search query, are not sub-phrases of one or more phrases, appear at least once in data referenced by the subset of search results, have a computed weight exceeding a predetermined value, or appear in paragraphs that include at least one of terms of the search query; and
present the identified one or more terms as possible query refinements.

21. A computer program product embodied on a non-transitory computer readable storage medium containing computer instructions that, when executed on at least one processor-based device, cause the at least one processor-based device to:
receive a search query provided via an interface;
submit the search query to at least one of a plurality of search engines, each having a dedicated search engine interface, the dedicated search engine interface of the at least one of the plurality of search engines being hidden from view by the interface;
select a subset of search results returned by the at least one of the plurality of search engines; and
determine a set of possible query variations based on the selected subset of search results, the set of possible query variations being used to determine one or more refined queries for resubmission to the at least one of the plurality of search engines.
